(19) United States
(12) Patent Application Publication
(10) Pub. No.: US 2019/0351715 A1
(43) Pub. Date: Nov. 21, 2019

(54) PNEUMATIC TIRE

(71) Applicant: Toyo Tire Corporation, Itami-shi (JP)

(72) Inventor: Tetsuji Miyazaki, Itami-shi (JP)

(73) Assignee: Toyo Tire Corporation, Itami-shi (JP)

(21) Appl. No.: 16/401,365

(22) Filed: May 2, 2019

(30) Foreign Application Priority Data
May 17, 2018 (JP) 2018-095678

(51) Int. Cl. B60C 11/13; B60C 11/12

(52) U.S. Cl. CPC B60C 11/1315; B60C 2011/0346; B60C 11/1272

(57) ABSTRACT

The pneumatic tire according to the present embodiment includes a shoulder land portion that is formed between a ground contact end and the shoulder main groove, a central land portion that is formed on the other side of the shoulder main groove in the tire width direction, a plurality of first inclined grooves that are provided in the central land portion at intervals in the tire circumferential direction, and a plurality of second inclined grooves that are provided in the shoulder land portion at intervals in the tire circumferential direction. The first inclined groove of which one end is open to the shoulder main groove and the other end terminates in the central land portion extends in a direction inclined with respect to the tire circumferential direction, and the second inclined groove is open to the shoulder main groove and provided on an extension of the first inclined groove.

### BACKGROUND OF THE INVENTION

### Field of the Invention

The present invention relates to a pneumatic tire.

### Background Art

In the related art, it is known that a pneumatic tire is provided with an inclined groove which extends in a direction inclined with respect to a tire circumferential direction, in which one end is open to a shoulder main groove and the other end terminates in a central land portion on the central land portion formed at a center of the shoulder main groove in a tire width direction (for example, refer to JP-A-2000-238510).

### SUMMARY OF THE INVENTION

In a pneumatic tire provided with this type of an inclined groove, when the tire rotates in one direction on a wet road surface, water on the road surface flows through the inclined groove and is discharged to a shoulder main groove outside in the tire width direction. However, the water discharged from the inclined groove to the shoulder main groove may collide with a groove wall of the shoulder main groove and is likely to stay in a connecting portion between the inclined groove and the shoulder main groove and may not be discharged smoothly.

Therefore, an object of the present invention is to prevent a water discharged from an inclined groove to a shoulder main groove from staying in a connecting portion between the inclined groove and the shoulder main groove when a tire rotates, and to enhance drainage performance, in a pneumatic tire including a plurality of inclined grooves in which one end is open to the shoulder main groove and the other end terminates in a central land portion, and extends in a direction inclined with respect to a tire circumferential direction.

According to an aspect of the present invention, there is provided a pneumatic tire including a shoulder main groove that is disposed on one side in a tire width direction from a tire equatorial plane and extends in a tire circumferential direction, a shoulder land portion that is formed between a ground contact end and the shoulder main groove, a central land portion that is formed on the other side of the shoulder main groove in the tire width direction, a plurality of first inclined grooves that are provided in the central land portion at intervals in the tire circumferential direction, and a plurality of second inclined grooves that are provided in the shoulder land portion at intervals in the tire circumferential direction, in which the first inclined groove of which one end is open to the shoulder main groove and the other end terminates in the central land portion extends in a direction inclined with respect to the tire circumferential direction, and the second inclined groove is open to the shoulder main groove and provided on an extension of the first inclined groove.

According to the present invention, since the second inclined groove is provided on the extension of the first inclined groove which is provided in the central land portion, the water discharged from the first inclined groove to the shoulder main groove is discharged to the second inclined groove, staying of water at the connecting portion between the inclined groove and the shoulder main groove can be suppressed, and drainage performance can be enhanced.

### BRIEF DESCRIPTION OF THE DRAWINGS

FIG. 1 is a developed view illustrating a tread pattern of a pneumatic tire according to an embodiment of the present invention.

FIG. 2 is a cross-sectional view taken along line II-II of FIG. 1.

FIG. 3 is an enlarged view of a main part in a vicinity of a first shoulder land portion of the tread pattern.

FIG. 4 is an enlarged view of a main part in a vicinity of a second shoulder land portion of the tread pattern.

FIG. 5 is a cross-sectional view taken along line V-V in FIG. 4.

FIG. 6 is a cross-sectional view taken along line VI-VI in FIG. 4.

FIG. 7 is an enlarged view of a main part in a vicinity of a first shoulder land portion in a pneumatic tire according to a modification example of the present invention.

### DETAILED DESCRIPTION OF THE INVENTION

Hereinafter, an embodiment of the present invention will be described with reference to the drawings.

A pneumatic tire according to the embodiment is not illustrated, and is configured to include a pair of left and right bead portions and sidewall portions, and a tread portion provided between both of the sidewall portions so as to connect radially outer end portions of the left and right sidewall portions. The pneumatic tire can adopt a general tire structure except for a tread pattern.

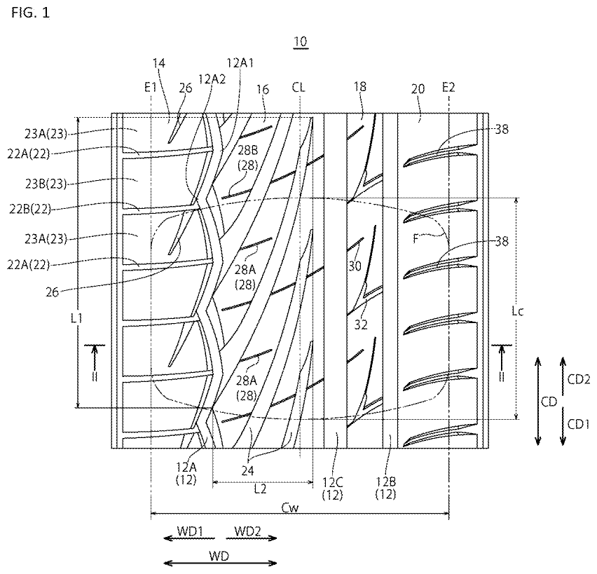

In FIG. 1, a reference sign F indicates a grounding shape in a state where the pneumatic tire is mounted on a normal rim, is placed vertically on a flat road surface in a state of being filled with a normal internal pressure, and is applied with a normal load. The reference signs E1 and E2 indicate ground contact ends in the same state. The reference sign E1 indicates the ground contact end on one side WD1 in a tire width direction (hereinafter, may be referred to as first ground contact end). The reference sign E2 indicates the ground contact end on the other side WD2 in the tire width direction (hereinafter, may be referred to as second ground contact end).

In addition, each dimension in the present specification is in an unloaded normal condition in which the pneumatic tire is mounted on the normal rim and filled with the normal internal pressure. In addition, a ground contact length Lc on a tire equator is a ground contact length on a tire equatorial plane in a state where the pneumatic tire is mounted on the normal rim, is filled with the normal internal pressure to be placed vertically on the flat road surface, and is applied with the normal load. A ground contact width Cw is a width between the ground contact ends E1 and E2 on both sides grounding the road surface in the load state.

The normal rim is a rim that specified by the standard for each tire in the standard system including the standard that the tire is based on. For example, in the case of JATMA, it is a standard rim, in the case of TRA, it is a “design rim”, and in the case of ETRTO, it is a “measuring rim”. The normal internal pressure is an air pressure specified by each standard for each tire in the standard system including the standard that the tire is based on. In the case of JATMA, it is a highest air pressure, in the case of TRA, it is a maximum value described in the table “tire load limits at various cold inflation pressures”, and in the case of ETRTO, it is an “inflation pressure”.

In addition, the normal load is a load specified by each standard for each tire in the standard system including the standard that the tire is based on. In the case of JATMA, it is a maximum load capacity, in the case of TRA, it is a maximum value described in the above table, and in the case of ETRTO, it is a “load capacity”.

As illustrated in FIG. 1, on a tread rubber surface of a tread portion 10, a plurality of main grooves 12 extending in a tire circumferential direction CD are provided. In this example, three are formed at intervals in a tire width direction WD.

Specifically, a first shoulder main groove 12A, a second shoulder main groove 12B, and a center main groove 12C are provided on the tread rubber surface of the tread portion 10. The first shoulder main groove 12A is provided on the one side WD1 in a tire width direction (left side in FIG. 1) from the tire equatorial plane CL. The second shoulder main groove 12B and the center main groove 12C are provided on the other side WD2 in the tire width direction (right side in FIG. 1) from the tire equatorial plane CL.

The first shoulder main groove 12A is a zigzag groove in which inward bent portions 12A1 and outward bent portions 12A2 are alternately and repeatedly disposed in the tire circumferential direction CD. That is, the first shoulder main groove 12A is continuously connected in the tire circumferential direction CD while being bent with amplitude in the tire width direction WD.

The second shoulder main groove 12B is a straight groove continuously connected in the tire circumferential direction CD, and is disposed at a position closest to the other side WD2 in the tire width direction.

The center main groove 12C is a straight groove continuously connected in the tire circumferential direction CD, and is provided between the first shoulder main groove 12A and the second shoulder main groove 12B.

In the tread portion 10, a plurality of land portions are partitioned by a main groove 12 in the tire width direction WD. Specifically, a first shoulder land portion 14 formed between the first ground contact end E1 and the first shoulder main groove 12A, a first central land portion 16 interposed between the first shoulder main groove 12A and the center main groove 12C (that is, formed on the other side of the first shoulder main groove 12A in the tire width direction), a second central land portion 18 formed between the center main groove 12C and the second shoulder main groove 12B, and a second shoulder land portion 20 formed between the second ground contact end E2 and the second shoulder main groove 12B are provided in the tread portion 10.

The first shoulder land portion 14 is provided with a plurality of slits 22 and a plurality of second inclined grooves 26 at intervals in the tire circumferential direction CD.

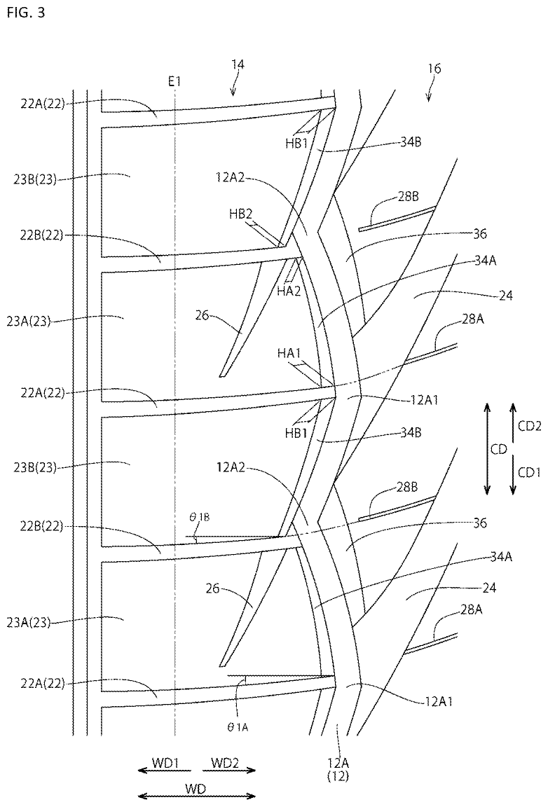

As illustrated in FIGS. 1 and 3, the slits 22 provided in the first shoulder land portion 14 divide the first shoulder land portion 14 in the tire circumferential direction CD to form a plurality of blocks 23. That is, the first shoulder land portion 14 forms block rows in which the plurality of blocks 23 are disposed in the tire circumferential direction CD.

In the slit 22, the other side WD2 in the tire width direction is provided with a first slit 22A connected to the inward bent portion 12A1 and a second slit 22B connected to the outward bent portion 12A2 of the first shoulder main groove 12A. The first slit 22A and the second slit 22B extend from the first shoulder main groove 12A to the one side WD1 in the tire width direction beyond the first ground contact end E1. The length along the tire width direction WD of the first slit 22A connected to the inward bent portion 12A1 is longer than that of the second slit 22B connected to the outward bent portion 12A2.

The first slit 22A and the second slit 22B may be provided in parallel to the tire width direction WD, or may be gradually inclined toward one side CD1 in the tire circumferential direction (downward in FIG. 1) as approaching the one side WD1 in the tire width direction. In a case where the first slit 22A and the second slit 22B are inclined with respect to the tire width direction WD, it is preferable that the angles θ1A and θ1B of the first slit 22A and the second slit 22B with respect to the tire width direction WD are 10 degrees or less.

In addition, the first slit 22A and the second slit 22B may be recessed grooves linearly extending in the tire width direction WD, or may be curved recessed grooves gradually curved as illustrated in FIG. 1. In a case where the first slit 22A and the second slit 22B are the curved recessed grooves, although an inclination angle with respect to the tire width direction WD changes depending on the position in the tire width direction WD, in that case, it is preferable that the maximum value of the angle with respect to the tire width direction WD (in FIG. 1, angle at the connecting portion with the first shoulder main groove 12A) is 10 degrees or less.

The plurality of blocks 23 forming the first shoulder land portion 14 is provided with a first block 23A and a second block 23B. In the first block 23A, the one side CD1 in the tire circumferential direction is partitioned by the first slit 22A, and the other side CD2 in the tire circumferential direction is partitioned by the second slit 22B. The one side CD1 in the tire circumferential direction of the second block 23B is partitioned by the second slit 22B, and the other side CD2 in the tire circumferential direction is partitioned by the first slit 22A. The first block 23A and the second block 23B are alternately disposed and form the first shoulder land portion 14 in the tire circumferential direction CD.

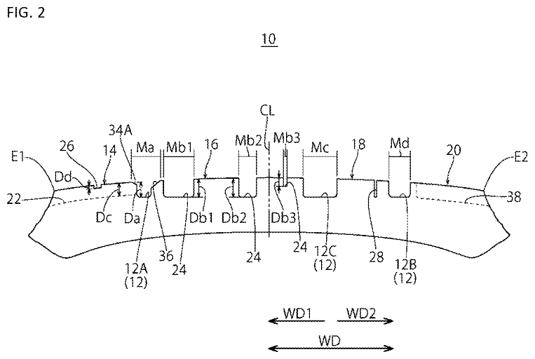

Each of the plurality of first blocks 23A forming the first shoulder land portion 14 is provided with the second inclined groove 26 whose one end is open to the first shoulder main groove 12A. The second inclined groove 26 is provided on the extension of a first inclined groove 24. That is, the second inclined groove 26 is connected to the outward bent portion 12A2, and is inclined so as to be directed to the one side WD1 in the tire width direction as approaching the one side CD1 in the tire circumferential direction. A groove depth Dd of the second inclined groove 26 is smaller than groove depths Da and Dc of the first shoulder main groove 12A and the slit 22 (refer to FIG. 2). The second inclined groove 26 is gradually narrowed in the groove width as approaching the one side WD1 in the tire width direction (that is, as separating from the first shoulder main groove 12A).

Here, as an example of dimensions, the groove depth Da of the first shoulder main groove 12A can be 6 to 10 mm, the groove depths Db1 to Db3 of the first inclined groove 24 can be 6 to 10 mm, the groove depth Dc of the slit 22 can be 4 to 8 mm, and the groove depth Dd of the second inclined groove 26 can be 1 to 2 mm.

In addition, as illustrated in FIG. 3, in the first block 23A and the second block 23B forming the first shoulder land portion 14, a first chamfered portion 34A and a second chamfered portion 34B are provided on the groove wall facing the first shoulder main groove 12A.

A surface width of the first chamfered portion 34A provided in the first block 23A gradually increases from the outward bent portion 12A2 side of the first shoulder main groove 12A as approaching the one side CD1 in the tire circumferential direction. A surface width of the second chamfered portion 34B provided in the second block 23B gradually increases from the outward bent portion 12A2 side of the first shoulder main groove 12A as approaching the other side CD2 in the tire circumferential direction.

That is, the surface widths of the first chamfered portion 34A and the second chamfered portion 34B gradually increase in the direction from the outward bent portion 12A2 side toward the inward bent portion 12A1 of the first shoulder main groove 12A. At that time, in the first chamfered portion 34A and the second chamfered portion 34B, it is preferable that the surface widths HA1 and HB1 on the inward bent portion 12A1 side of the first shoulder main groove 12A are twice or less of the surface widths HA2 and HB2 on the outward bent portion 12A2 side.

The surface width is a length along the slopes of the chamfered portions 34A and 34B in the width direction of the first shoulder main groove 12A.

As described above, when the surface widths HA1 and HB1 on the inward bent portion 12A1 side of the first shoulder main groove 12A are twice or less the surface widths HA2 and HB2 of the outward bent portion 12A2, even with the first chamfered portion 34A and the second chamfered portion 34B, the zigzag shape of the first shoulder main groove 12A can be maintained. Therefore, the flow velocity of the air passing through the inside of the first shoulder main groove 12A at the time of traveling can be reduced, and noise due to air column resonance can be suppressed.

The first central land portion 16 is provided with a plurality of first inclined grooves 24 and a plurality of sipes 28 at intervals in the tire circumferential direction CD. The first inclined groove 24 is a groove in which the one side WD1 in the tire width direction is open to the inward bent portion 12A1 of the first shoulder main groove 12A and the other side WD2 in the tire width direction terminates in the first central land portion 16, and extends in a direction inclined with respect to the tire circumferential direction.

The first central land portion 16 is provided with a tapered surface 36 which is inclined so that the groove width of the first shoulder main groove 12A widens as approaching the ground contact surface from the groove bottom side on the wall surface facing the first shoulder main groove 12A.

The first inclined groove 24 extends in the tire circumferential direction CD while separating from the first shoulder main groove 12A toward the other side WD2 in the tire width direction, so that the length L1 along the tire circumferential direction CD is 90% or more and 180% or less of the ground contact length Lc on the tire equator, and the length L2 along the tire width direction WD to be 30% or more of the ground contact width Cw.

The plurality of the first inclined grooves 24 are provided at intervals in the tire circumferential direction CD as described above. At this time, the first inclined grooves 24 adjacent to each other in the tire circumferential direction CD are provided in parallel in the tire circumferential direction CD so that at least a portion of the projection view projected in the tire circumferential direction CD overlap each other. That is, the first inclined grooves 24 are provided at intervals in the tire circumferential direction CD so that a portion of the first inclined grooves 24 overlaps the first inclined grooves 24 adjacent in the tire circumferential direction CD in the tire width direction WD.

It is preferable that in the first inclined groove 24, an inclination angle with respect to the tire circumferential direction CD changes so as to approach the tire circumferential direction CD as approaching the other side WD2 in the tire width direction from the first shoulder main groove 12A (that is, to reduce angle to the tire circumferential direction CD). In addition, it is preferable that the first inclined groove 24 has a tapered shape in which the groove width along the tire width direction WD is reduced as approaching the other side WD2 in the tire width direction from the first shoulder main groove 12A.

In addition, in the first inclined groove 24, a groove depth Db3 on the first shoulder main groove 12A side may be shallower than a groove depth Db1 on the other side WD2 in the tire width direction (refer to FIG. 2).

The plurality of sipes 28 are cuts having a minute groove width (normally 1 mm or less), and more specifically, a groove in which a pneumatic tire mounted on a normal rim and filled with a normal internal pressure contacts the ground, and under the condition that a normal load is applied thereto, the opening portion to the ground contact surface closes.

The sipe 28 is provided with a first sipe 28A disposed on the other side WD2 in the tire width direction of the first slit 22A and a second sipe 28B disposed on the other side WD2 in the tire width direction of the second slit 22B. The first sipe 28A and the second sipe 28B are alternately disposed in the tire circumferential direction CD.

The first sipe 28A and the second sipe 28B are gradually curved so that the angle with respect to the tire circumferential direction CD reduces as approaching the other side WD2 in the tire width direction from the first shoulder main groove 12A side.

In the first sipe 28A, the one side WD1 in the tire width direction is open to the first inclined groove 24, and the groove wall of the one side CD1 in the tire circumferential direction of the first sipe 28A extends along an extension line in which the groove wall of the other side CD2 in the tire circumferential direction of the first slit 22A is smoothly extended to the other side WD2 in the tire width direction. In the first sipe 28A, the other side WD2 in the tire width direction terminates in the first central land portion 16 without intersecting the first inclined groove 24.

In the second sipe 28B, the one side WD1 in the tire width direction terminates in the first central land portion 16, and the groove wall of the one side CD1 in the tire circumferential direction of the second sipe 28B extends along an extension line in which the groove wall of the other side CD2 in the tire circumferential direction of the second slit 22B is smoothly extended to the other side WD2 in the tire width direction. The second sipe 28B is provided to intersect the first inclined groove 24, and the other side WD2 in the tire width direction is open to the center main groove 12C.

The second central land portion 18 is provided with a third sipe 30 extending along an extension line in which the second sipe 28B provided in the first central land portion 16 is extended, and a lateral groove 32.

A plurality of shoulder lateral grooves 38 are provided in the second shoulder land portion 20 at intervals in the tire circumferential direction CD.

The shoulder lateral groove 38 is formed of a recessed groove extending in the tire width direction WD while gradually curving so that the angle with respect to the tire width direction WD reduces as approaching the other side WD2 in the tire width direction.

The shoulder lateral groove 38 terminates in the second shoulder land portion 20 without the one side WD1 in the tire width direction opening in the second shoulder main groove 12B, and the other side WD2 in the tire width direction extends beyond the second ground contact end E2. The second shoulder land portion 20 forms a rib-like land portion connected in the tire circumferential direction CD on the one side WD1 in the tire width direction by such a shoulder lateral groove 38.

The second shoulder lateral grooves 38 may be provided in parallel to the tire width direction WD, or may be provided to be gradually inclined with respect to the tire width direction WD. In addition, the second shoulder lateral groove 38 may be a linearly extending recessed groove, or may be a gradually curving curved recessed groove.

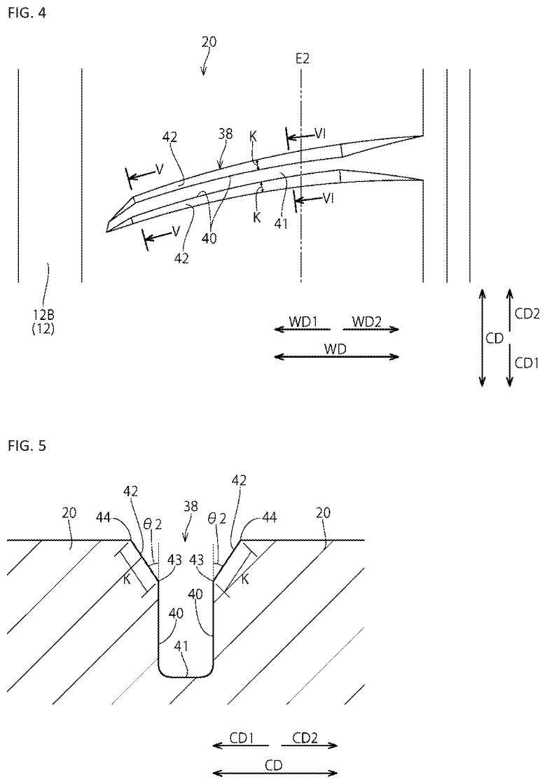

As illustrated in FIGS. 4 to 6, the second shoulder lateral grooves 38 is partitioned by a pair of groove walls 40 provided at predetermined intervals in the tire circumferential direction CD, a groove bottom 41 connecting the pair of groove walls 40 inward the groove wall 40 in the tire radial direction, and a pair of tapered surfaces 42 provided on a tread surface (ground contact surface) side of the pair of groove walls 40.

The pair of groove walls 40 rise from the groove bottom 41 substantially in the tire radial direction, and are provided in parallel to each other at a constant interval over the entire tire width direction WD.

The pair of tapered surfaces 42 is separated from each other as approaching the ground contact surface from the groove bottom 41 side, and is inclined so that the groove width of the shoulder lateral groove 38 gradually increases. In addition, in the pair of tapered surfaces 42, a length K along the groove width direction of the shoulder lateral groove 38 gradually increases as approaching the second ground contact end E2 from the one side WD1 toward the other side WD2 in the tire width direction. That is, the width of the pair of tapered surfaces 42 increases as approaching from the one side WD1 toward the other side WD2 in the tire width direction.

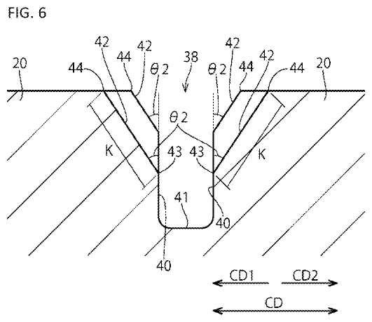

As illustrated in FIGS. 5 and 6, in the present embodiment, a boundary portion 43 between the tapered surface 42 and the groove wall 40 approaches the groove bottom 41, and a boundary portion 44 between the tapered surface 42 and the ground contact surface extends outside the second shoulder lateral groove 38, as approaching the second ground contact end E2 from the one side WD1 to the other side WD2 in the tire width direction, while keeping the angle θ2 of the tapered surface 42 with respect to the groove wall 40 constant.

In the pneumatic tire according to the present embodiment as described above, the water in the first central land portion 16 is discharged to the first shoulder main groove 12A when the tire rotates to the one side CD1 in the tire circumferential direction on a wet road surface. At that time, since the second inclined groove 26 which is open to the first shoulder main groove 12A and provided on the extension of the first inclined groove 24 is disposed in the first shoulder land portion 14, the water discharged from the first inclined groove 24 to the first shoulder main groove 12A can be discharged to the second inclined groove 26 without staying in the connecting portion between the first shoulder main groove 12A and the first inclined groove 24. Therefore, the water is smoothly discharged in the first shoulder main groove 12A, and the water is also smoothly discharged in the first shoulder main groove 12A.

In addition, when the pneumatic tire according to the present embodiment rotates to the other side CD2 in the tire circumferential direction, the water of the first shoulder land portion 14 is guided to the first shoulder main groove 12A by the second inclined groove 26, and is smoothly discharged.

In addition, by providing the slit 22 extending in the tire width direction WD in the first shoulder land portion 14 as in the present embodiment, the water in the first shoulder main groove 12A can be discharged to the outside from the slit 22, and drainage performance can be further improved. Furthermore, in the present embodiment, since the groove depth of the second inclined groove 26 provided in the first shoulder main groove 12A is shallower than these of the first shoulder main groove 12A and the slit 22, it is possible to suppress the decrease in steering stability caused by the decrease in the rigidity of the first shoulder land portion 14.

In addition, in the present embodiment, since the first shoulder main groove 12A is a zigzag groove in which the inward bent portion 12A1 and the outward bent portion 12A2 are alternately and repeatedly disposed, the first inclined groove 24 is connected to the inward bent portion 12A1, and the second inclined groove 26 is connected to the outward bent portion 12A2, a sharp acute land portion is not formed between the first shoulder main groove 12A and the first inclined groove 24 and the first shoulder main groove 12A and the second inclined groove 26. Therefore, it is possible to suppress the occurrence of uneven wear due to a local decrease in rigidity.

In addition, since the slit 22 provided in the first shoulder land portion 14 is connected to the inward bent portion 12A1 of the first shoulder main groove 12A, a sharp acute land portion is not formed between the first shoulder main groove 12A and the slit 22, and it is possible to suppress the occurrence of uneven wear due to a local decrease in rigidity.

In addition, in a case where the length L2 of the first inclined groove 24 in the tire width direction WD of the first inclined groove 24 is 30% or more of the ground contact width Cw as in the present embodiment, the improvement of the drainage performance by the first inclined groove 24 is remarkable, which is preferable.

### Modification Example

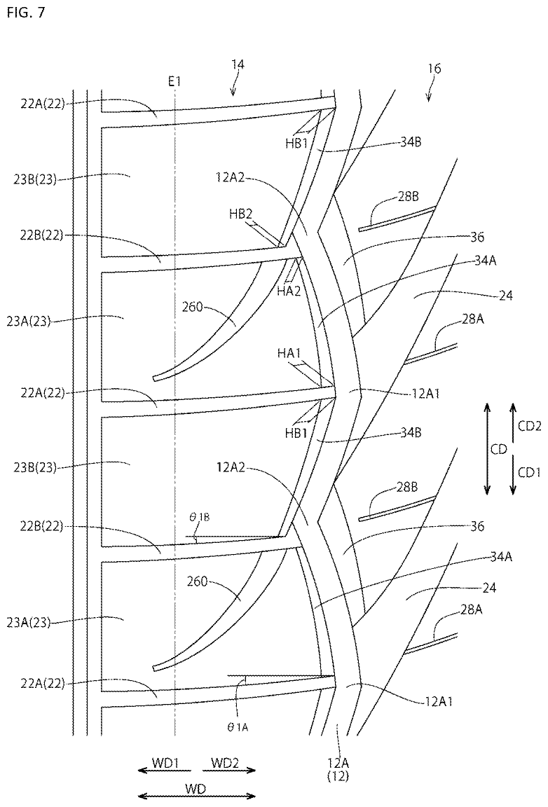

In the above embodiment, although the case where the second inclined groove 26 provided in the second shoulder land portion 20 extends from the first shoulder main groove 12A to the one side WD1 in the tire width direction and terminates at the other side (center side in the width direction) WD2 in the width direction from the first ground contact end E1 is described, for example, as illustrated in FIG. 7, the second inclined groove 260 may extend from the first ground contact end E1 to one side (outer side in the width direction) WD1 in the width direction.

By extending the second inclined groove 260 connected to the first shoulder main groove 12A from the first ground contact end E1 to the one side WD1 in the width direction as described above, water flowing into the second inclined groove 260 from the first inclined groove 24 via the first shoulder main groove 12A is likely to be discharged to the outside, and the drainage performance can be enhanced.

The above embodiments are presented by way of example only, and are not intended to limit the scope of the invention. This novel embodiment can be implemented in other various forms, and various omissions, replacements, and changes can be made without departing from the scope of the invention.

What is claimed is:

1. A pneumatic tire comprising:
a shoulder main groove that is disposed on one side in a tire width direction from a tire equatorial plane and extends in a tire circumferential direction;
a shoulder land portion that is formed between a ground contact end and the shoulder main groove;
a central land portion that is formed on the other side of the shoulder main groove in the tire width direction;
a plurality of first inclined grooves that are provided in the central land portion at intervals in the tire circumferential direction; and
a plurality of second inclined grooves that are provided in the shoulder land portion at intervals in the tire circumferential direction,
wherein the first inclined groove of which one end is open to the shoulder main groove and the other end terminates in the central land portion extends in a direction inclined with respect to the tire circumferential direction, and
the second inclined groove is open to the shoulder main groove and provided on an extension of the first inclined groove.

2. The pneumatic tire according to claim 1,
wherein the shoulder land portion includes a block row divided in the tire circumferential direction by a slit extending in the tire width direction, and
the second inclined groove is shallower than the shoulder main groove and the slit.

3. The pneumatic tire according to claim 1,
wherein the shoulder main groove includes a zigzag groove in which an inward bent portion and an outward bent portion are alternately and repeatedly disposed.

4. The pneumatic tire according to claim 3,
wherein the first inclined groove is connected to the inward bent portion, and the second inclined groove is connected to the outward bent portion.

5. The pneumatic tire according to claim 3,
wherein the slit is connected to the inward bent portion.

6. The pneumatic tire according to claim 1, further comprising:
one or a plurality of main grooves extending in the tire circumferential direction on the other side in the tire width direction from the tire equatorial plane; and
a rib-like second shoulder land portion continuous in the circumferential direction between the main groove and the ground contact end,
wherein a length of the first inclined groove in the tire width direction is 30% or more of a ground contact width.

7. The pneumatic tire according to claim 1,
wherein the second inclined groove extends from the ground contact end to an outer side in the tire width direction.

8. The pneumatic tire according to claim 2,
wherein the shoulder main groove includes a zigzag groove in which an inward bent portion and an outward bent portion are alternately and repeatedly disposed.

9. The pneumatic tire according to claim 4,
wherein the slit is connected to the inward bent portion.
